(19) United States
(12) Patent Application Publication
(10) Pub. No.: US 2023/0284687 A1
(43) Pub. Date: Sep. 14, 2023

(54) APPARATUS FOR GENERATING AN INHALABLE MEDIUM

(71) Applicant: Nicoventures Trading Limited, LONDON (GB)

(72) Inventors: Patrick MOLONEY, London (GB); Jon Peter Frederick SPRATLEY, London (GB); Francesca Alys STEPHENS, London (GB); Andy FINCH, London (GB); Adam ROBINSON, London (GB); Simon James COPLEY, London (GB); Daniel Jerrad MOSS, London (GB)

(21) Appl. No.: 18/040,701

(22) PCT Filed: Aug. 5, 2021
(86) PCT No.: PCT/EP2021/071913

§ 371 Date: Feb. 6, 2023

(30) Foreign Application Priority Data
Aug. 5, 2020 (GB) 2012175.2

(51) Int. Cl. A24F 40/40; H05B 3/22; A24F 40/53; A24F 40/57

(52) U.S. Cl. CPC A24F 40/40; H05B 3/22; A24F 40/53; A24F 40/57

(57) ABSTRACT

An aerosol provision device is disclosed comprising a chamber (110) for receiving a consumable (10) comprising aerosol-generating material, wherein, in use, part (12) of the consumable (10) protrudes from the chamber (110). The device further comprises an aerosol generator (120) for generating an inhalable medium from the consumable 10 received in the chamber (110) and a controller (130) for controlling the supply of power from a power source (140) to the aerosol generator (120). A movable component (150) is provided for at least partially covering the part (12) of the consumable (10) that protrudes from the chamber (110) in use, wherein the movable component 150 is movable between a first position, in which the part (12) of the consumable (10) is exposed, and a second position, in which the part (12) of the consumable (10) is at least partially covered. The controller (130) is configured to supply a different amount of power when the movable component (150) is in the first position compared with when the movable component (150) is in the second position.

### PRIORITY CLAIM

The present application is a National Phase entry of PCT Application No. PCT/EP2021/071913, filed Aug. 5, 2021, which claims priority from GB Application No. 2012175.2, filed Aug. 5, 2020, each of which hereby fully incorporated herein by reference.

### TECHNICAL FIELD

The present disclosure relates to an apparatus and a system for generating an inhalable medium. An example of an apparatus for generating inhalable medium is an aerosol provision device. An example of a system for generating an inhalable medium is an aerosol provision system comprising the aerosol provision device and a consumable including an aerosol-generating material.

### BACKGROUND

Smoking articles such as cigarettes, cigars and the like burn tobacco during use to create tobacco smoke. Attempts have been made to provide alternatives to these articles that burn tobacco by creating products that release compounds without burning. Examples of such products are heating devices which release compounds by heating, but not burning, the material. The material may be for example tobacco or other non-tobacco products, which may or may not contain nicotine.

### SUMMARY

According to an aspect there is provided an aerosol provision device. The device is for generating an inhalable medium. The device comprises a chamber for receiving a consumable comprising aerosol-generating material, wherein, in use, part of the consumable protrudes from the chamber. The device comprises an aerosol generator for generating an inhalable medium from the consumable received in the chamber. The device comprises a controller for controlling the supply of power from a power source to the aerosol generator. The device comprises a movable component for at least partially covering the part of said consumable that protrudes from the chamber in use, wherein the movable component is movable between a first position, in which the part of the consumable is exposed, and a second position, in which the part of the consumable is at least partially covered. The controller is configured to supply a different amount of power when the movable component is in the first position compared with when the movable component is in the second position. In some embodiments, the controller is configured to supply no power to the aerosol generator when the movable component is in the second position. In other embodiments, the controller is for controlling the supply of power such that some power is supplied when the movable component is in the second position but that the level of power supplied is insufficient for generating the inhalable medium.

In some embodiments, the movable component is configured such that, in the second position, the movable component at least partially covers an opening into the chamber, the consumable being insertable into the chamber via the opening.

In some embodiments, the movable component is configured to rotate about a hinge between the first and second positions.

In some embodiments, the movable component is configured to slide between the first and second positions.

In some embodiments, the movable component is completely detachable from the device such that, in the first position, the movable component is removed from a main body of the device and, in the second position, the movable component is removably connected to the main body of the device.

In some embodiments, the aerosol provision device comprises a retraction mechanism movable between an extended position in which, in use, the part of the consumable is exposed, and a retracted position in which, in use, the part of the consumable is at least partially retracted into the chamber compared with when the retraction mechanism is in the extended position.

In some embodiments, the retraction mechanism comprises a rotational mechanism configured to move the retraction mechanism between the extended and retracted positions.

In some embodiments, the aerosol provision device comprises a plurality of external components rotatable relative each other wherein a first one of the plurality of external components is configured to rotate relative a second one of the plurality of external components to move the retraction mechanism between the extended and retracted positions.

In some embodiments, the retraction mechanism comprises a slider configured to move the retraction mechanism between the extended and retracted positions, wherein, in use, the slider causes the consumable to translate relative to the chamber along a longitudinal axis of the chamber.

In some embodiments, movement of the movable component is coupled to movement of the retraction mechanism such that the movable component is in the first position when the retraction mechanism is in the extended position and the movable component is in the second position when the retraction mechanism is in the retracted position.

In some embodiments, the aerosol provision device comprises a biasing member to bias the movable component towards the first position and/or the second position.

In some embodiments, the aerosol provision device comprises a locking member to lock the movable component in the first position and/or the second position.

In some embodiments, when the movable component is in the first position, the controller is configured to supply more power from the power source to the aerosol generator than when the movable component is in the second position.

In some embodiments, when the movable component is in the first position, the controller is configured to supply sufficient power from the power source to the aerosol generator to generate an aerosol from the aerosol-generating material.

In some embodiments, in use, the controller is configured to heat the consumable according to a predetermined heating profile when the movable component is in the first position and to interrupt the predetermined heating profile in the event that the movable component is moved to the second position, and wherein the controller is configured to resume heating the consumable according to the predetermined heating profile in the event that the movable component is returned to the first position.

In some embodiments, in use, the controller is configured to cause movement of the movable component from the first position to the second position in the event that a predetermined amount of time has elapsed since a puff by a user.

In some embodiments, in use, the controller is configured to cause movement of the movable component from the first position to the second position a predetermined amount of time after the start of a usage session.

In some embodiments, the aerosol provision device comprises a sensor to detect a position of the movable component, wherein the controller is configured to supply power to the aerosol generator from the power supply in accordance with the position of the movable component as determined by the sensor.

In some embodiments, when the movable component is in the second position, the controller is configured to supply power from the power source to the aerosol generator to maintain the aerosol-generating material within a temperature range below an aerosol-generating temperature of the aerosol-generating material.

In some embodiments, when the movable component is in the second position, the controller is configured to supply no power from the power source to the aerosol generator.

According to an aspect there is provided an aerosol provision system comprising an aerosol provision device according to the first aspect of the present disclosure and a consumable comprising aerosol-generating material, the consumable configured for receipt in the chamber of the device. In use, the device is configured to generate an inhalable medium from the aerosol-generating material.

According to an aspect there is provided an aerosol provision device. The aerosol provision device is for generating an inhalable medium. The aerosol provision device comprises: an aerosol generating zone for receiving a consumable comprising aerosol-generating material; a reciprocation component; a housing member for at least partially housing the reciprocation component; and a driving member movable relative the housing member to cause relative reciprocation between the reciprocation component and the housing member, in use.

In some embodiments, the driving member is configured to move about an axis to cause the relative reciprocation between the reciprocation component and the housing member.

In some embodiments, the driving member is configured to move about the axis of reciprocation to cause the relative reciprocation between the reciprocation component and the housing member.

In some embodiments, the driving member is rotatable relative the housing member about an axis of rotation. In some embodiments, the axis of rotation of the driving member is parallel to an axis of reciprocation of the reciprocation component.

In some embodiments, the driving member is rotatable relative the housing member to cause relative reciprocation between the reciprocation component and the housing member, in use.

In some embodiments, the driving member is configured to move along an axis parallel to the axis of reciprocation to cause the relative reciprocation between the reciprocation component and the housing member. In some embodiments, the driving member is configured to move along the axis of reciprocation to cause the relative reciprocation between the reciprocation component and the housing member.

In some embodiments, the driving member is configured to move about the axis of reciprocation to cause the relative reciprocation between the reciprocation component and the housing member.

In some embodiments, movement of the driving member comprises movement along a helical path.

In some embodiments, the reciprocation component is configured to move along the axis of reciprocation to cause the relative reciprocation between the reciprocation component and the housing member.

In some embodiments, the reciprocation component is configured to move about the axis of reciprocation to cause the relative reciprocation between the reciprocation component and the housing member.

In some embodiments, movement of the reciprocation component comprises movement along a helical path.

In some embodiments, the housing member and reciprocation component are rotatable relatively each other, such that, when the driving member causes the relative reciprocation between the reciprocation component and the housing member, the housing member and reciprocation component rotate relative each other.

In some embodiments, the aerosol provision device comprises a casing formed by the housing member and the driving member.

In some embodiments, the reciprocation component is a mouthpiece through which aerosol generated from the aerosol-generating material is drawn by a user of the aerosol provision device.

In some embodiments, the reciprocation component is a chamber configured to receive the consumable comprising aerosol-generating material.

In some embodiments, the housing member is movable in combination with the driving member to cause relative reciprocation between the reciprocation component and the housing member, in use. In some embodiments, movement of the driving member and the housing member comprises movement along a respective helical path.

According to an aspect there is provided an aerosol provision system. The aerosol provision system comprises the aerosol provision device according to the third aspect of the present disclosure, wherein the reciprocation component is the consumable comprising aerosol-generating material.

According to an aspect there is provided a method of arranging an aerosol provision device comprising: a driving member; a housing member; and a reciprocation component. The method comprises: relatively moving the driving member and the housing member for at least partially housing the reciprocation component to cause relative reciprocation between the reciprocation component and the housing member.

In some embodiments, the relative reciprocation causes an uncovering, at least partially, of the reciprocation component by the housing member.

In some embodiments, the relative reciprocation causes a covering, at least partially, of the reciprocation component by the housing member.

In some embodiments, the relatively moving to cause the uncovering, at least partially, of the reciprocation component by the housing member comprises relatively rotating the driving member and the housing member in a first direction, and the relatively moving to cause the covering, at least partially, of the reciprocation component by the housing member comprises relatively rotating the driving member and the housing member in the first direction.

In some embodiments, the relatively moving to cause the uncovering, at least partially, of the reciprocation component by the housing member comprises relatively rotating the driving member and the housing member in a first direction, and the relatively moving to cause the covering, at least partially, of the reciprocation component by the housing member comprises relatively rotating the driving member and the housing member in a second direction, different to the first direction. In some embodiments, the first direction is in a direction opposite the first direction.

In some embodiments, the relatively moving to cause the uncovering, at least partially, of the reciprocation component by the housing member comprises relatively rotating the driving member and the housing member forwards along a path, and the relatively moving to cause the covering, at least partially, of the reciprocation component by the housing member comprises relatively rotating the driving member and the housing member backwards along the path.

Further features and advantages of the disclosure will become apparent from the following description of embodiments of the disclosure, given by way of example only, which is made with reference to the accompanying drawings.

### BRIEF DESCRIPTION OF THE DRAWINGS

Embodiments of the disclosure will now be described, by way of example only, with reference to accompanying drawings, in which:

FIGS. 1a and 1b show a cross sectional view of an aerosol provision device according to an embodiment of the disclosure;

FIGS. 2a and 2b show a cross sectional view of an aerosol provision device according to an embodiment of the disclosure;

FIGS. 3a and 3b show a cross sectional view of an aerosol provision device according to an embodiment of the disclosure;

FIGS. 4a and 4b show a cross sectional view of an aerosol provision device according to an embodiment of the disclosure;

FIG. 4c shows a side view of aerosol provision device according to an embodiment of the disclosure;

FIG. 5 is a graphical representation of heating profiles provided by an aerosol provision device according to an embodiment of the disclosure;

FIGS. 6a and 6b show a schematic representation of an aerosol provision device according to an embodiment of the disclosure;

FIGS. 7a and 7b show a schematic representation of an aerosol provision device according to an embodiment of the disclosure; and

FIG. 8 shows an illustration of a method of arranging an aerosol provision device according to an embodiment of the disclosure.

### DETAILED DESCRIPTION

The present disclosure relates to aerosol provision devices, such as noncombustible aerosol provision devices, and to aerosol provision systems, such as noncombustible aerosol provision systems. According to the present disclosure, a “noncombustible” aerosol provision device is one where a constituent aerosol-generating material comprised by a consumable for receipt by a chamber of the aerosol provision device (or component thereof) is not combusted or burned in order to facilitate delivery of the aerosol-generating material to a user. In some embodiments, the aerosol provision system, such as the non-combustible aerosol provision system, comprises an aerosol provision device (sometimes referred to herein as an apparatus), such as a noncombustible aerosol provision device, and a consumable for use with the aerosol provision device, the consumable including an aerosol-generating material.

As used herein, the term “aerosol-generating material” includes materials that provide volatilised components upon heating, typically in the form of an aerosol. Aerosol-generating material includes any tobacco-containing material and may, for example, include one or more of tobacco, tobacco derivatives, expanded tobacco, reconstituted tobacco or tobacco substitutes. Aerosol-generating material also may include other, nontobacco, products, which, depending on the product, may or may not contain nicotine. Aerosol-generating material may for example be in the form of a solid, a liquid, a gel, a wax or the like. Aerosol-generating material may for example also be a combination or a blend of materials. Aerosol-generating material may comprise a flavourant. Aerosol-generating material may also be known as “smokable material” or “aerosolisable material”.

As used herein, the term “tobacco material” refers to any material comprising tobacco or derivatives therefore. The term “tobacco material” may include one or more of tobacco, tobacco derivatives, expanded tobacco, reconstituted tobacco or tobacco substitutes. The tobacco material may comprise one or more of ground tobacco, tobacco fibre, cut tobacco, extruded tobacco, tobacco stem, reconstituted tobacco and/or tobacco extract.

The tobacco used to produce tobacco material may be any suitable tobacco, such as single grades or blends, cut rag or whole leaf, including Virginia and/or Burley and/or Oriental. It may also be tobacco particle ‘fines’ or dust, expanded tobacco, stems, expanded stems, and other processed stem materials, such as cut rolled stems. The tobacco material may be a ground tobacco or a reconstituted tobacco material. The reconstituted tobacco material may comprise tobacco fibres, and may be formed by casting, a Fourdrinier-based paper making-type approach with back addition of tobacco extract, or by extrusion.

In some embodiments, the aerosol provision system is an electronic cigarette, also known as a vaping device or electronic nicotine delivery system (END), although it is noted that the presence of nicotine in the aerosol-generating material is not a requirement.

In some embodiments, the aerosol provision system is a tobacco heating system, also known as a heat-not-burn system.

In some embodiments, the aerosol provision system is a hybrid system to generate aerosol using a combination of aerosol-generating materials, one or a plurality of which may be heated. Each of the aerosol-generating materials may be, for example, in the form of a solid, liquid or gel and may or may not contain nicotine. In some embodiments, the hybrid system comprises a liquid or gel aerosol-generating material and a solid aerosol-generating material. The solid aerosol-generating material may comprise, for example, tobacco or a non-tobacco product.

In some embodiments, the aerosol provision system may comprise a power source. The power source may, for example, be an electric power source.

In some embodiments, the consumable for use with the aerosol provision device may comprise an aerosol generating component, an aerosol generating area, a mouthpiece, and/or an area for receiving aerosol-generating material.

A consumable is an article comprising or consisting of aerosol-generating material, part or all of which is intended to be consumed during use by a user. A consumable may comprise one or more other components, such as an aerosol-generating material storage area, an aerosol-generating material transfer component, an aerosol generation area, a housing, a wrapper, a mouthpiece, a filter and/or an aerosol-modifying agent. A consumable may also comprise an aerosol generator, such as a heater, that emits heat to cause the aerosol-generating material to generate aerosol in use. The heater may, for example, comprise combustible material, a material heatable by electrical conduction, or a susceptor.

In some embodiments, the aerosol generating component is a heater capable of interacting with the aerosol-generating material so as to release one or more volatiles from the aerosol-generating material to form an aerosol. In some embodiments, the aerosol generating component is capable of generating an aerosol from the aerosol-generating material without heating. For example, the aerosol generating component may be capable of generating an aerosol from the aerosol-generating material without applying heat thereto, for example via one or more of vibrational, mechanical, pressurisation or electrostatic means. In some embodiments, the aerosol generating component may form part of the aerosol provision device.

In some embodiments, a substance to be delivered by the aerosol provision device may be an aerosol-generating material which may comprise an active constituent, a carrier constituent and optionally one or more other functional constituents.

The active constituent may comprise one or more physiologically and/or olfactory active constituents which are included in the aerosol-generating material in order to achieve a physiological and/or olfactory response in the user. The active constituent may for example be selected from nutraceuticals, nootropics, and psychoactives. The active constituent may be naturally occurring or synthetically obtained. The active constituent may comprise for example nicotine, caffeine, taurine, theine, a vitamin such as B6 or B12 or C, melatonin, or a constituent, derivative, or combinations thereof. The active constituent may comprise a constituent, derivative or extract of tobacco or of another botanical. In some embodiments, the active constituent is a physiologically active constituent and may be selected from nicotine, nicotine salts (e.g. nicotine ditartrate/nicotine bitartrate), nicotine-free tobacco substitutes, other alkaloids such as caffeine, or mixtures thereof.

In some embodiments, the active constituent is an olfactory active constituent and may be selected from a “flavour” and/or “flavourant” which, where local regulations permit, may be used to create a desired taste, aroma or other somatosensorial sensation in a product for adult consumers. In some instances such constituents may be referred to as flavours, flavourants, cooling agents, heating agents, or sweetening agents. They may include naturally occurring flavour materials, botanicals, extracts of botanicals, synthetically obtained materials, or combinations thereof (e.g., tobacco, cannabis, licorice (liquorice), hydrangea, eugenol, Japanese white bark magnolia leaf, chamomile, fenugreek, clove, maple, matcha, menthol, Japanese mint, aniseed (anise), cinnamon, turmeric, Indian spices, Asian spices, herb, Wintergreen, cherry, berry, red berry, cranberry, peach, apple, orange, mango, clementine, lemon, lime, tropical fruit, papaya, rhubarb, grape, durian, dragon fruit, cucumber, blueberry, mulberry, citrus fruits, Drambuie, bourbon, scotch, whiskey, gin, tequila, rum, spearmint, peppermint, lavender, aloe vera, cardamom, celery, cascarilla, nutmeg, sandalwood, bergamot, geranium, khat, naswar, betel, shisha, pine, honey essence, rose oil, vanilla, lemon oil, orange oil, orange blossom, cherry blossom, cassia, caraway, cognac, jasmine, ylang-ylang, sage, fennel, wasabi, piment, ginger, coriander, coffee, hemp, a mint oil from any species of the genus Mentha, eucalyptus, star anise, cocoa, lemongrass, rooibos, flax, ginkgo biloba, hazel, hibiscus, laurel, mate, orange skin, rose, tea such as green tea or black tea, thyme, juniper, elderflower, basil, bay leaves, cumin, oregano, paprika, rosemary, saffron, lemon peel, mint, beefsteak plant, curcuma, cilantro, myrtle, cassis, valerian, pimento, mace, damien, marjoram, olive, lemon balm, lemon basil, chive, carvi, verbena, tarragon, limonene, thymol, camphene), flavour enhancers, bitterness receptor site blockers, sensorial receptor site activators or stimulators, sugars and/or sugar substitutes (e.g., sucralose, acesulfame potassium, aspartame, saccharine, cyclamates, lactose, sucrose, glucose, fructose, sorbitol, or mannitol), and other additives such as charcoal, chlorophyll, minerals, botanicals, or breath freshening agents. They may be imitation, synthetic or natural ingredients or blends thereof. They may be in any suitable form, for example, liquid such as an oil, solid such as a powder, or gasone or more of extracts (e.g., licorice, hydrangea, Japanese white bark magnolia leaf, chamomile, fenugreek, clove, menthol, Japanese mint, aniseed, cinnamon, herb, Wintergreen, cherry, berry, peach, apple, Drambuie, bourbon, scotch, whiskey, spearmint, peppermint, lavender, cardamom, celery, cascarilla, nutmeg, sandalwood, bergamot, geranium, honey essence, rose oil, vanilla, lemon oil, orange oil, cassia, caraway, cognac, jasmine, ylang-ylang, sage, fennel, piment, ginger, anise, coriander, coffee, or a mint oil from any species of the genus Mentha), flavour enhancers, bitterness receptor site blockers, sensorial receptor site activators or stimulators, sugars and/or sugar substitutes (e.g., sucralose, acesulfame potassium, aspartame, saccharine, cyclamates, lactose, sucrose, glucose, fructose, sorbitol, or mannitol), and other additives such as charcoal, chlorophyll, minerals, botanicals, or breath freshening agents. They may be imitation, synthetic or natural ingredients or blends thereof. They may be in any suitable form, for example, oil, liquid, or powder.

In some embodiments, the flavour comprises menthol, spearmint and/or peppermint. In some embodiments, the flavour comprises flavour components of cucumber, blueberry, citrus fruits and/or redberry. In some embodiments, the flavour comprises eugenol. In some embodiments, the flavour comprises flavour components extracted from tobacco. In some embodiments, the flavour comprises flavour components extracted from cannabis. In some embodiments, the flavour may comprise a sensate, which is intended to achieve a somatosensorial sensation which are usually chemically induced and perceived by the stimulation of the fifth cranial nerve (trigeminal nerve), in addition to or in place of aroma or taste nerves, and these may include agents providing heating, cooling, tingling, numbing effect. A suitable heat effect agent may be, but is not limited to, vanillyl ethyl ether and a suitable cooling agent may be, but not limited to eucalyptol, WS-3.

The carrier constituent may comprise one or more constituents capable of forming an aerosol. In some embodiments, the carrier constituent may comprise one or more of glycerine, glycerol, propylene glycol, diethylene glycol, triethylene glycol, tetraethylene glycol, 1, 3-butylene glycol, erythritol, meso-Erythritol, ethyl vanillate, ethyl laurate, a diethyl suberate, triethyl citrate, triacetin, a diacetin mixture, benzyl benzoate, benzyl phenyl acetate, tributyrin, lauryl acetate, lauric acid, myristic acid, and propylene carbonate.

The one or more other functional constituents may comprise one or more of pH regulators, colouring agents, preservatives, binders, fillers, stabilizers, and/or antioxidants.

In some embodiments, the consumable for use with the aerosol provision device may comprise aerosol-generating material or an area for receiving aerosol-generating material. In some embodiments, the consumable for use with the aerosol provision device may comprise a mouthpiece. The area for receiving aerosol-generating material may be a storage area for storing aerosol-generating material. For example, the storage area may be a reservoir. In some embodiments, the area for receiving aerosol-generating material may be separate from, or combined with, an aerosol generating area.

Apparatus is known that heats aerosol-generating material to volatilise at least one component of the aerosol-generating material, typically to form an aerosol which can be inhaled, without burning or combusting the aerosol-generating material. Such apparatus is sometimes described as an “aerosol generating device”, an “aerosol provision device”, a “heat-not-burn device”, a “tobacco heating product device” or a “tobacco heating device” or similar. Similarly, there are also so-called e-cigarette devices, which typically vaporise an aerosol-generating material in the form of a liquid, which may or may not contain nicotine. The aerosol-generating material may be in the form of or be provided as part of a rod, cartridge or cassette or the like which can be inserted into the apparatus.

An aerosol generator is an apparatus configured to cause aerosol to be generated from the aerosol-generating material. In some embodiments, the aerosol generator is a heater configured to subject the aerosol-generating material to heat energy, so as to release one or more volatiles from the aerosol-generating material to form an aerosol. In some embodiments, the aerosol generator is configured to cause an aerosol to be generated from the aerosol-generating material without heating. For example, the aerosol generator may be configured to subject the aerosol-generating material to one or more of vibration, increased pressure, or electrostatic energy. The aerosol generator may be provided as a “permanent” part of the aerosol provision device.

An apparatus such as an aerosol provision device can receive a consumable comprising aerosol-generating material for heating. A consumable is an article comprising or consisting of aerosol-generating material, part or all of which is intended to be consumed during use by a user. A consumable may comprise one or more other components, such as an aerosol-generating material storage area, an aerosol-generating material transfer component, an aerosol generation area, a housing, a wrapper, a mouthpiece, a filter and/or an aerosol-modifying agent. A consumable may also comprise an aerosol generator, such as a heater, that emits heat to cause the aerosol-generating material to generate aerosol in use. The heater may, for example, comprise combustible material, a material heatable by electrical conduction, or a susceptor.

A susceptor is a material that is heatable by penetration with a varying magnetic field, such as an alternating magnetic field. The susceptor may be an electrically-conductive material, so that penetration thereof with a varying magnetic field causes induction heating of the heating material. The heating material may be magnetic material, so that penetration thereof with a varying magnetic field causes magnetic hysteresis heating of the heating material. The susceptor may be both electrically-conductive and magnetic, so that the susceptor is heatable by both heating mechanisms. The device that is configured to generate the varying magnetic field is referred to as a magnetic field generator.

A user may insert the consumable into the aerosol provision device before it is heated to produce an aerosol, which the user subsequently inhales. The consumable may be, for example, of a predetermined or specific size that is configured to be placed within a chamber, such as a heating chamber, of the device which is sized to receive the consumable.

During a usage session, a user may be interrupted for any number of reasons. The present disclosure provides an apparatus, such as an aerosol provision device, that allows a user to leave a consumable comprising aerosol-generating material arranged in the apparatus during such an interruption, and then to resume the usage session at a suitable time.

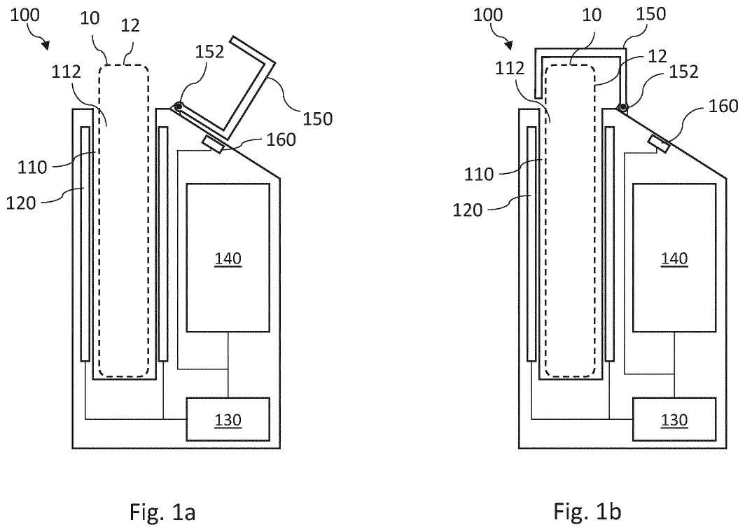

FIGS. 1a-1d show a cross sectional view of embodiments of an aerosol provision device 100 for generating an inhalable medium according to an embodiment of the present disclosure. The device 100 comprises a chamber 110 for receiving a consumable 10 including aerosol-generating material. In use, part 12 of the consumable 10 protrudes from the chamber 110 so that it is accessible for inhalation by a user. In other embodiments, the consumable 10 may not protrude from the chamber 110 in use. For example, an opening of the chamber 110 may be covered by a mouthpiece (not shown) separate to the consumable 10. In some embodiments, the consumable 10 may comprise a mouthpiece through which a user can draw the generated inhalable medium.

In some embodiments, the chamber 110 comprises an interface (not shown) configured to engage with the consumable 10 to retain the consumable 10 at a predetermined position in the chamber 110. In this embodiment, the consumable 10 is insertable into the chamber 110 via an opening 112 at an end of the chamber 110. In other embodiments, the consumable 10 may be insertable into the chamber from a side of the chamber 110.

The device 100 comprises an aerosol generator 120 for generating an inhalable medium from the consumable 10 received in the chamber 110. By way of example, the aerosol generator 120 may be configured to supply heat to the aerosol-generating material of the consumable 10 to generate the inhalable medium. The aerosol generator 120 may comprise one or more of an electrical resistance heater and an induction heater, for example. Alternatively, pressure could be used to generate an inhalable medium from the consumable. In the embodiment shown in FIGS. 1a and 1 b, the aerosol generator 120 substantially surrounds the chamber 110 along its longitudinal length. In other embodiments, the aerosol generator 120 may extend only partially along the chamber and/or may be positioned elsewhere relative to the chamber 110. For example, the aerosol generator 120 may be positioned within the chamber 110.

The device 100 comprises a movable component 150 for at least partially covering the part 12 of the consumable 10 that protrudes from the chamber 110 in use. The movable component 150 is movable between a first position (as shown in FIGS. 1a and 1c) and a second position (as shown in FIGS. 1b and 1d). In the first position, the part 12 of the consumable 10 is exposed, and a user may puff on the consumable 10 to inhale a medium generated by the device 100. In the second position, the part 12 of the consumable 10 is at least partially covered, such that a user is prevented from puffing on the consumable 10. In some embodiments, the movable component 150 is configured such that, in the second position, the movable component 150 at least partially covers the opening 112 in the chamber 110 through which the consumable 10 is insertable. The movable component 150 may be of any suitable shape to at least partially cover the part 12 of the consumable 10 when the movable component 150 is in the second position. In other embodiments, the movable component 150 may cover all of the part 12 of the consumable 10 that is exposed when the consumable 10 is in the chamber 110. In yet other embodiments, the movable component 150 may substantially surround the part 12 of the consumable 10 and may not cover an end surface 14 of the consumable 10.

When use of the device 100 is interrupted, the movable component 150 may be moved from the first position to the second position to at least partially cover the part 12 of the consumable 10. During an interruption, the movable component 150 being in the second position may help to reduce one or more of: heat loss from the consumable 10 and/or the heating chamber 110, contamination of the consumable 10 and damage to the consumable 10.

The movable component 150 is configured to rotate about a hinge 152 between the first and second positions, as shown in FIGS. 1a and 1b. The hinge 152 may be of any suitable form. The hinge 152 may be located at a fixed position relative to the chamber 110. In some embodiments, the movable component 150 may be configured to move along a path between the first and second positions, as shown in FIGS. 1c and 1d. For example, the movable component 150 may be mounted to a carriage 154 that is slidable relative to the chamber 110. In the embodiment shown in FIGS. 1c and 1d, the movable component 150 is configured to rotate about a hinge 152, and the hinge 152 is mounted to a carriage 154 that is slidable from a first position distal to the chamber 110 and a second position proximal to the chamber 110. Such a configuration may help to keep the movable component 110 clear of the consumable 10 in use to improve comfort for a user.

In some embodiments, the movable component 150 is movable between the first and second positions by a user manually moving the movable component 150. In other embodiments, the device 100 may comprise a mechanical actuator (not shown in FIGS. 1a and 1b) for moving the movable component 150 between the first and second positions. The actuator may be, for example, in the form of a slider or a button and/or the movable component may be motorised. The actuator may comprise a biasing means, such as a spring or a magnet, to hold the movable component in the first and/or second position.

In some embodiments, the movable component 150 may be configured such that, in the second position, residual heat can escape from the chamber 110, which may help to prevent the formation of condensation in the chamber 110 during an interruption of a usage session. For example, if the movable component 150 is configured such that the opening 112 of the chamber 110 is substantially sealed by the movable component 150 in the second position, the movable component 150 may comprise one or more holes or pores (not shown) for ventilation purposes. The movable component 150 may substantially seal the opening 112 of the chamber 110 by means of a locking mechanism, as described in greater detail below.

The device 100 comprises a controller 130 for controlling the supply of power from a power source 140 to the aerosol generator 120. The power source 140 may comprise, for example, a rechargeable battery that is integral to the device 100, or a replaceable battery. Operation of the controller 130 is described herein with reference to FIGS. 1a-40.

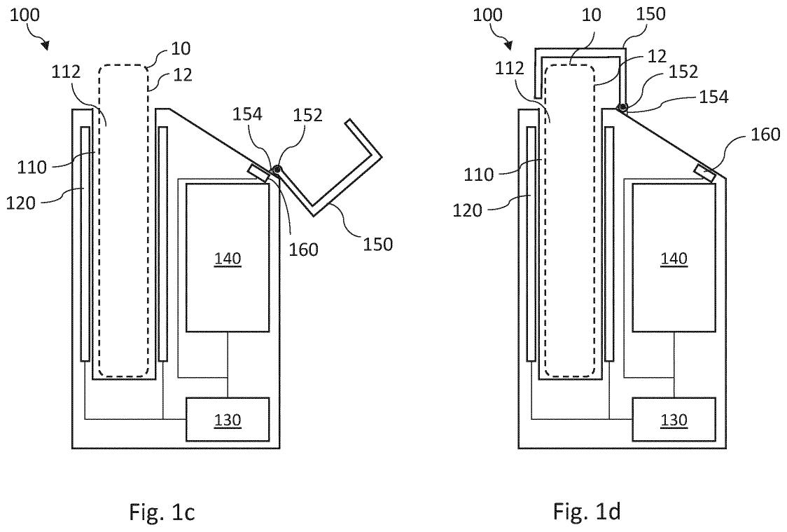

FIGS. 2a and 2b show a cross sectional view of a device 200 for generating an inhalable medium according to an embodiment of the disclosure. The device 200 is substantially the same as the device 100 described with reference to FIGS. 1a and 1 b, and similar components have reference numbers that are increased by 100. In this embodiment, the movable component 250 is completely detachable. In the first position, the movable component 250 is removed from a main body of the device, and in the second position, the movable component 250 is removably connected to the main body of the device. Such a configuration may help to decrease the complexity of the device 200 because the movable component 250 is not movably attached to the device 200.

In the embodiment shown in FIGS. 2a and 2b, the movable component 250, in the second position, covers the opening 212 of the chamber 210 to enclose the consumable 10. In other embodiments, the movable component 250 may only partially cover the part 12 of the consumable 10 that is exposed.

The device 200 may comprise a retention member 270 to hold the movable component 250 in the second position. The retention member 270 may help to prevent unintentional movement of the movable component 250 from the second position to the first position. In the embodiment of FIGS. 2a and 2b, the retention member 270 is in the form of an annular protrusion 272 at the opening 212 of the chamber 210 and an annular recess 256 of the movable component 250 to cooperate with the annular protrusion 272, as clearly shown in FIG. 2b. The cooperation of the annular protrusion 272 and the annular recess 256 may increase the force necessary to remove the movable component 250 from the second position, which may help to prevent unintentional removal of the movable component 250. A retention member 270 may also be provided in other embodiments of the disclosure, for example in the device 100 described with reference to FIGS. 1a and 1b, to hold the movable component 150 in the first and/or second position. The retention member 270 could also take the form of a magnetic attachment or an alternative mechanical fastening, such as a screw thread and threaded barrel.

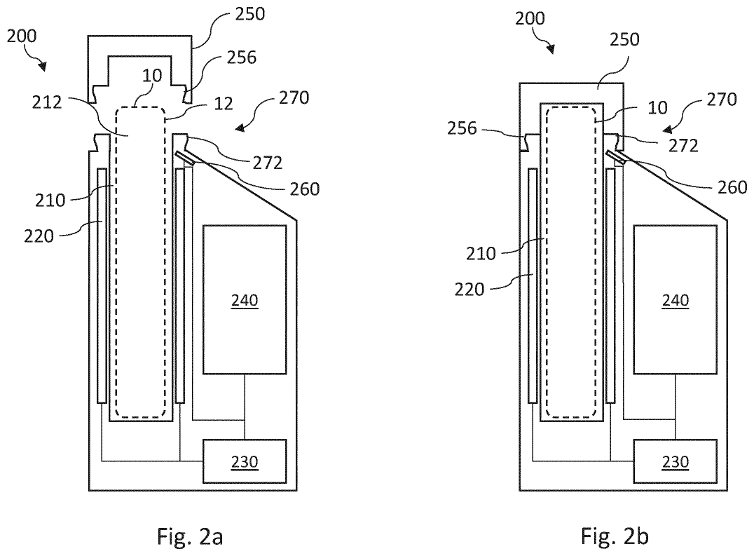

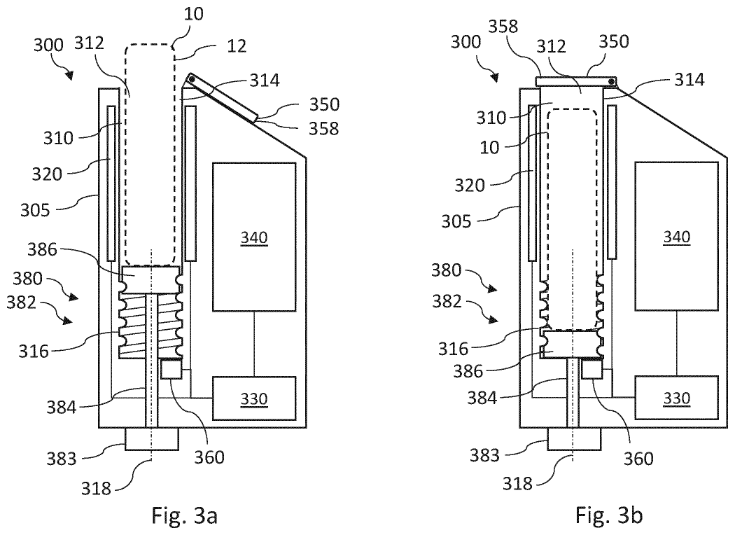

FIGS. 3a, 3b, 4a and 4b show cross sectional views of devices 300, 400 for generating an inhalable medium according to an embodiment of the disclosure. The devices 300, 400 are substantially similar to the devices 100, 200 as described with reference to FIGS. 1a, 1 b, 2a and 2b. Similar components in the devices 300, 400 have the same reference numbers as those of FIGS. 1a and 1 b, but increased by 200 or 300, respectively.

The devices 300, 400 comprise a retraction mechanism 380, 480. The retraction mechanism 380, 480 is movable between an extended position (as shown in FIGS. 3a and 4a) in which, in use, the part 12 of the consumable 10 is exposed for inhalation, and a retracted position (as shown in FIGS. 3b and 4b) in which, in use, the part 12 of the consumable 10 is at least partially retracted into the chamber 310, 410 compared with when the retraction mechanism 380, 480 is in the extended position. The retraction mechanism 380, 480 may help to prevent damage and contamination of the consumable during an interruption of a usage session.

In the embodiments shown in FIGS. 3a, 3b, 4a and 4b, the retraction mechanism 380, 480 is manually operable by a user, as will be described with reference to each of the devices 300, 400 in more detail. In other embodiments, the retraction mechanism 380, 480 may be electronically or electro-mechanically operated by the controller 330, 430. This may provide the advantage of minimising the number of moving parts on an outer surface of the device 300, 400.

The device 300 comprises a plurality of external components. A first one of the plurality of external components is a housing member 305. The housing member 305 houses various internal components of the device 300. In this embodiment, the housing member 305 houses the controller 330 and the power source 340, for example.

In the device 300 shown in FIGS. 3a and 3b, the retraction mechanism 380 comprises a rotational mechanism 382 configured to move the retraction mechanism 380 between the extended position (FIG. 3a) and the retracted position (FIG. 3b). By way of example, in the embodiment shown in FIGS. 3a and 3b, the inner surface 314 of the chamber 310 comprises a threaded portion 316 configured to engage with a correspondingly threaded consumable support 386, upon which the consumable 10 rests in use. The consumable support 386 is connected to a knob 383 on an outer surface of the device 300 via a connector 384. In this embodiment, the connector 384 is a connecting rod. In other embodiments, the connector 384 (or connecting rod) may comprise a plurality of parts.

The knob 383 is an example of a second one of the plurality of external components of the device 100. The movable component 350 is an example of a third another one of the plurality of external components of the device 100. The consumable support 386 is an example of a reciprocation component that is configured to reciprocate along an axis of reciprocation. In this embodiment, the axis of reciprocation corresponds to a longitudinal axis 318 of the chamber 310. In other embodiments, the axis of reciprocation may be parallel to the longitudinal axis 318 of the chamber 310 but not coexistent with the longitudinal axis 318 of the chamber 310. In yet further embodiments, the axis of reciprocation may be perpendicular or oblique to the longitudinal axis 318 of the chamber 310.

The retraction mechanism 380 is moved between the extended position and the retracted position by a user twisting the knob 383, which causes the consumable support 386 to turn about the longitudinal axis 318 of the chamber 310 to move longitudinally relative to the threaded portion 316. The knob 383 is therefore a driving member that is configured to rotate relative to the housing member 305 to cause the consumable support 386 to reciprocate relative to the housing member 305, in use. The threaded portion 316 may comprise a stop (not shown) at one or both ends to prevent the consumable support 386 from disengaging from the threaded portion 316. The consumable support 386 may comprise an interface (not shown) for releasably retaining the surface of the consumable 10 in contact with the consumable support 389.

In other embodiments, the rotational mechanism 382 may be configured to rotate the consumable 10 about an axis perpendicular to a longitudinal axis of the consumable 10 (not shown). For example, the rotational mechanism 382 may be configured to move the consumable 10 from a position in which the consumable 10 protrudes substantially perpendicularly from an outer surface of the device 300 to a position in which the consumable lies substantially parallel and flush to the outer surface of the device 300.

In the device 400 shown in FIGS. 4a and 4b, the retraction mechanism 480 comprises a slider 481 configured to move the retraction mechanism 480 between the extended position (FIG. 4a) and the retracted position (FIG. 4b). The aerosol generator of device 400 has been omitted in FIGS. 4a and 4b for simplicity. In use, the slider 481 is configured to cause the consumable 10 to translate relative to the chamber 410 along a longitudinal axis 418 of the chamber 410. By way of example, in the embodiment shown in FIGS. 4a and 4b, the inner surface 414 of the chamber 410 comprises a longitudinal slot 416 configured to receive the slider 481. The slider 481 comprises a handle 482 exterior to the device 400, a retraction bar 484 that extends through the longitudinal slot 416 from the handle 482 into the chamber 410, and a consumable support 486 connected to the end of the retraction bar 484 that extends into the chamber 410. Movement of the handle 482 between a first end and a second end of the longitudinal slot 416 by a user causes the consumable support 486 to move along the longitudinal axis 418 of the chamber 410 to move the consumable 10 relative to the chamber 410 in use. Other forms of slider are envisaged. The consumable support 486 may comprise an interface (not shown) for releasably retaining the surface of the consumable 10 in contact with the consumable support 486.

The retraction mechanism 480 shown in FIGS. 4a and 4b comprises a spring 488. The spring 488 acts as a biasing member to bias the slider 481 towards the extended position. In other embodiments, the spring 488 may alternatively bias the slider 481 towards the retracted position. The spring 488 is attached to the consumable support 486 and the end of the chamber 410 and exerts a pushing force on the consumable support 486 when the slider 481 is in the retracted position (FIG. 4b). In other embodiments the spring 488 may be positioned elsewhere. For example, the spring 488 may connect the retraction bar 484 to an end of the longitudinal slot 416. In other embodiments, a biasing force may be provided by means other than a spring 488.

The movable component 350, 450 of embodiments of the disclosure comprising a retraction mechanism 380, 480, such as the embodiments shown in FIGS. 3a, 3b, 4a and 4b, may comprise a lid 358, 458 movable between a first position in which, in use, the part 12 of the consumable 10 is exposed and a second position in which, in use, the part 12 of the consumable 20 is at least partially covered to retain the consumable 10 in the chamber 310, 410. The lid 358, 458 may be as described with reference to the movable members 150, 250 described with reference to FIGS. 1a, 1 b, 2a and 2b. Alternatively, the lid can be in the form of a simple flap or cover that can be slid between the first and second positions, or hinged to move between the first and second positions. In some embodiments, the lid 358, 458 substantially covers the opening 312, 412 in the chamber 310, 410 through which the consumable 10 is insertable when the lid 358, 438 is in the second position.

In some embodiments, movement of the movable component 350, 450 is coupled to movement of the retraction mechanism 380, 480 such that the movable component 350, 450 is in the first position when the retraction mechanism 380, 480 is in the extended position and the movable component 350, 450 is in the second position when the retraction mechanism 380, 480 is in the retracted position. In such embodiments, the movable component 350, 450 and the retraction mechanism 380, 480 may be mechanically, electro-mechanically or electrically coupled. For example, the controller 330, 430 may be configured to move the retraction mechanism 380, 480 and the movable component 350, 450 substantially simultaneously. This may, for example, help to prevent a user's finger from becoming caught in the opening 312, 412.

Devices 100, 200, 300, 400 according to the disclosure may comprise a locking mechanism 270, 470 to releasably lock the movable component 150, 250, 350, 450 in the first position and/or the second position. Any suitable locking mechanism 270, 470 may be employed, for example the retention member 270 as described with reference to FIGS. 2a and 2b. A magnetic locking mechanism may be arranged to retain the movable component 150, 250, 350, 450 in the first and/or second position. By way of example, the main body of the device 100, 200, 300, 400 and/or the movable component 150, 250, 350, 450 may comprise a magnet configured to attract a portion of the other of the main body of the device 100, 200, 300, 400 and the movable component 150, 250, 350, 450 to releasably hold the movable component 150, 250, 350, 450 in the first position or the second position. In some embodiments, locking may be achieved by a mechanical attachment means such as a projection cooperating with a groove or recess. In some embodiments, locking may be achieved by means of a resealable adhesive. In some embodiments, the locking mechanism 270, 470 may comprise an elastically deformable element configured to engage with the movable component 150, 250, 350, 450 to hold the movable component 150, 250, 350, 450 in a predetermined position, the elastically deformable element being movable by a user out of engagement with the movable component 150, 250, 350, 450 to release the movable component 150, 250, 350, 450 from the predetermined position. The locking mechanism 270, 470 may be controlled and/or actuated by the controller 130, 230, 330, 430.

By way of example only, FIG. 4c shows a locking mechanism 470 comprising a c-shaped channel 472 in an outer surface of the device 400 described with reference to FIGS. 4a and 4b. The ends 474, 476 of the channel 472 form grooves into which the retraction bar 484 is movable. In this embodiment, when the retraction mechanism 480 is in the first position and the retraction bar 484 is in the groove at the end 474 of the channel 472, the spring 488 is configured to apply a pulling force to the consumable support 484, which in turn pulls the retraction bar 484 into the groove and thus helps to prevent the retraction bar 484 from being inadvertently moved from its position. In some embodiments, when the retraction mechanism 480 is in the second position and the retraction bar 484 is in the groove at the end 476 of the channel 472, the spring 488 is configured to apply a pushing to the consumable support 486, which in turn pushes the retraction bar 484 into the groove and thus helps to prevent the retraction bar 484 from being inadvertently moved from its position. The retraction bar 484 can be released from the grooves at the ends 474, 476 of the channel 472 by a user applying a force to the handle 482 to overcome the biasing force of the spring 488. In other embodiments, the shape of the channel 472 may be altered compared with the example shown in FIG. 4c.

Devices according to the disclosure, such as the devices 100, 200, 300 and 400 described with reference to FIGS. 1a-4c) comprise a controller 130, 230, 330, 430 for controlling the supply of power from the power source 140, 240, 340, 440 to the aerosol generator 120, 220, 320, 420. A controller will be described with reference to the controller 130 of device 100, but the features may be present in any one of the embodiments of the disclosure. The controller 130 is configured to supply a different amount of power from the power source 140 to the aerosol generator 120 when the movable component 150 is in the first position compared with when the movable component is in the second position. When the movable component 150 is in the first position, the controller 130 may be configured to supply sufficient power from the power source 140 to the aerosol generator 120 to generate an aerosol from the aerosol-generating material of the consumable 10.

In some embodiments, the controller 130 may be configured to supply no power from the power source 140 to the aerosol generator 120 when the movable component 150 is in the second position. That is, the controller 130 is configured to supply power with a value of zero when the movable component 150 is in the second position such that no power delivery is provided to the aerosol generator 120. This may help to save energy to prolong the life of the power source 140.

In some embodiments, the controller 130 is configured to supply a value of nonzero when the movable component 150 is in the second position, but such that the value is insufficient for generating an inhalable medium from the consumable 10 received in the chamber 110. In this embodiment, the controller 130 may be active when the movable component 150 is in the second position but incapable of supplying enough power to generate an inhalable medium. In some embodiments, the non-zero value may correspond to negligible power when the movable component 150 is in the second position compared with when the movable component 150 is in the first position.

In some embodiments, the controller 130 is configured to supply more power from the power source 140 when the movable component 150 is in the first position than when the movable component 150 is in the second position. For example, when the movable component 150 is in the second position, the controller 130 may be configured to supply power from the power source 140 to the aerosol generator 120 to maintain the aerosol-generating material of the consumable 10 within a temperature range below an aerosol-generating temperature of the aerosol-generating material. In some embodiments, the aerosol-generating temperature is more than 160 degrees Celsius. In some embodiments, a maximum temperature of the temperature range is less than or equal to 160 degrees Celsius. In some embodiments, the temperature range is between 90 degrees Celsius and 160 degrees Celsius. Such a configuration may decrease the time taken to raise the aerosol-generating material to an aerosolising temperature when use of the device 100 is resumed after an interruption and the movable component 150 is moved from the second position to the first position. In some embodiments, the controller 130 may be configured to terminate the supply of power from the power source 140 to the aerosol generator 120 if the period of an interruption exceeds a certain time threshold. This may help to save energy to prolong the life of the power source 140.

In some embodiments, the device 100 comprises one or more sensors 160 to detect a position of the movable component 150, and the controller 130 is configured to supply power to the aerosol generator from the power supply 140 in accordance with the position of the movable component 150 as determined by the one or more sensors 160. For example, the one or more sensors 160 may comprise a switch, a pressure sensor and/or a proximity sensor such as an optical sensor. Each of the one or more sensors 160 may be positioned in the device 100 at a position suitable for detecting whether the movable component 150 in the first position or the second position (see, for example, various positions of sensors 260, 360, 460 shown in FIGS. 1a-4b).

In some embodiments, the controller 130 is configured to cause the movable component 150 to move between the first position and the second position. For example, the controller 130 may be configured to send an electrical signal to an actuator (not shown) for moving the movable component 150 between the first and second positions. The controller 130 may be configured to cause the moveable component 150 to move from the second position to the first position in response to a user actuating a power button (not shown) on the device 100. In some embodiments, the controller 130 may be configured to move the movable component 150 from the first position to the second position in the event that the controller determines that a usage session has been interrupted. For example, the controller 130 may move the movable component 150 from the first position to the second position in the event that the controller 130 detects that a predetermined amount of time has elapsed since a puff by a user, and/or that a predetermined amount of time after the start of a usage session has elapsed. Movement sensors may also be used to determine whether a device is in use depending on the degree to which the device is tilted, for example.

In embodiments according to the disclosure, the controller 130 may be configured to heat the consumable 10 according to a predetermined heating profile when the movable component 150 is in the first position, and to interrupt the heating profile in the event that the movable component 150 is moved to the second position. In such embodiments, the controller 130 may be configured to resume heating the consumable 10 according to the predetermined heating profile in the event that the movable component 150 is returned to the first position.

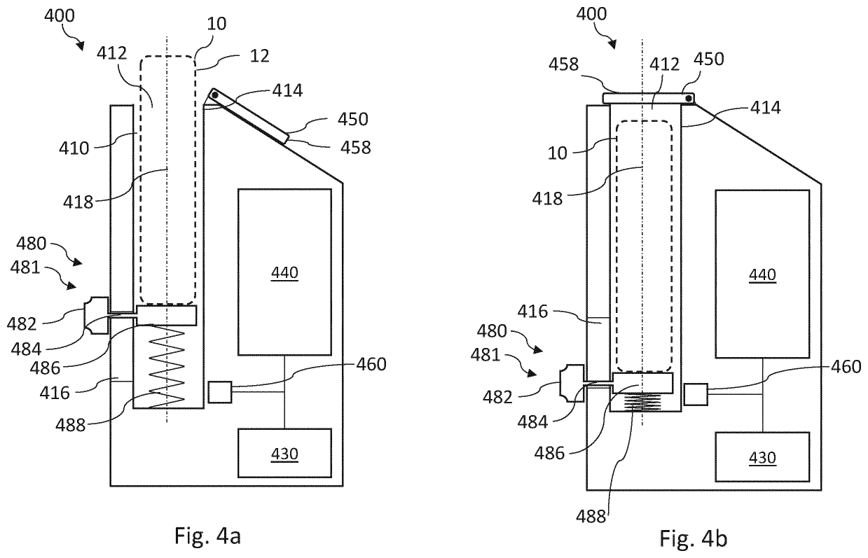

FIG. 5 shows, at line 500, an example heating profile delivered by the device 100, 200, 300, 400 to heat the aerosol-generating material of the consumable 10 when the movable component 150, 250, 350, 450 remains in the first position for the duration of the usage session. Temperature A denotes an aerosol-generating temperature of the aerosol-generating material, above which an aerosol is generated and below which an aerosol is not generated. TO denotes the time of starting a usage session, at which time, power is delivered to the aerosol generator 120, 220, 320, 420 to heat the consumable 10 to a temperature above the aerosol-generating temperature A.

FIG. 5 shows, at line 510, a usage session performed according to the example heating profile of line 500 being interrupted at time T1. The controller 130, 230, 330, 430 stops supplying power to the aerosol generator 120, 220, 320, 420 until the usage session is resumed at time T2, at which time the controller 130, 230, 330, 430 resumes the heating profile from the point at which it was interrupted.

FIG. 5 shows, at line 520, a usage session performed according to the example heating profile of line 500 being interrupted at time T1. In this embodiment, the controller 130, 230, 330, 430 reduces the power supplied to the aerosol generator 120, 220, 320, 420 so that the temperature is maintained within a temperature range below the aerosol-generating temperature A, until the usage session is resumed at time T2, at which time the controller 130, 230, 330, 430 resumes the heating profile from the point at which it was interrupted.

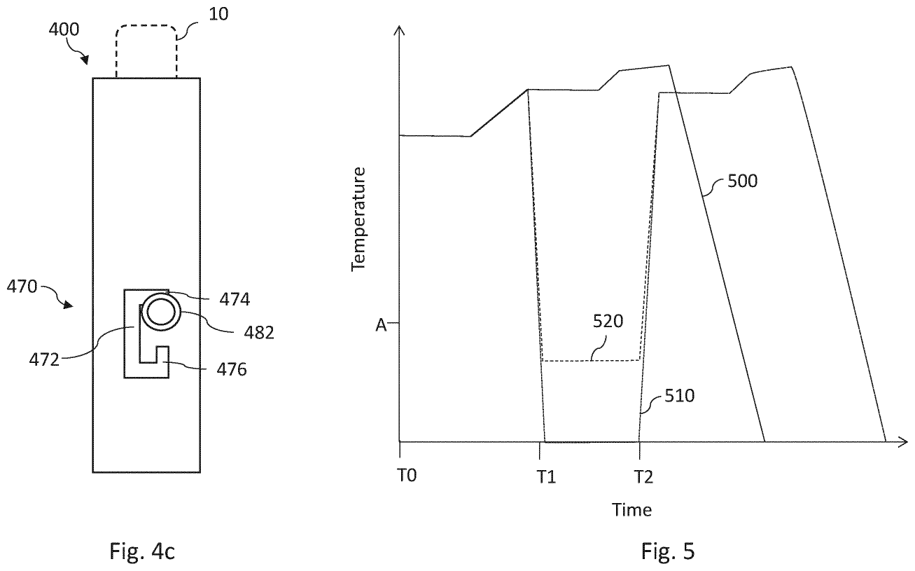

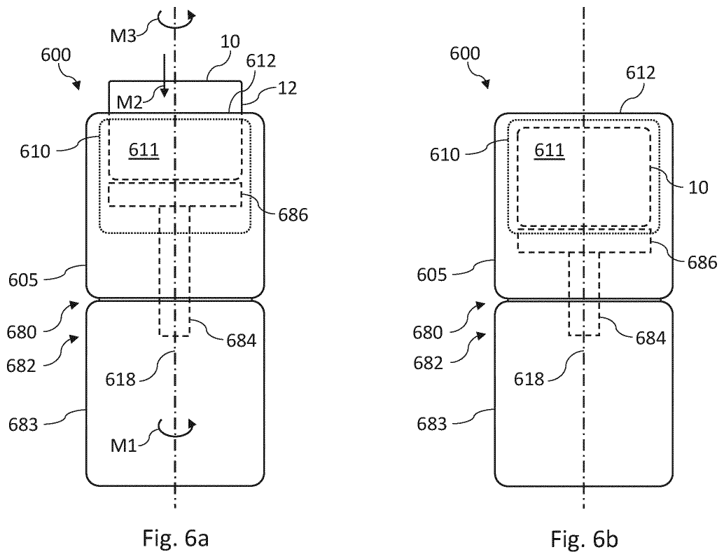

FIGS. 6a, 6b, 7a and 7b show schematic representations of aerosol provision devices 600, 700 for generating an inhalable medium according to embodiments of the disclosure. The devices 600, 700 are substantially similar to the devices 100, 200, 300, 400 as described with reference to FIGS. 1a, 1b, 2a, 2b, 3a, 3b, 4a, and 4b. Similar components in the devices 600, 700 have the same reference numbers as those of FIGS. 1a and 1b, but increased by 500 or 600, respectively.

The devices 600, 700 comprise respective retraction mechanisms 680, 780. As described with previous retraction mechanisms 380, 480, the retraction mechanisms 680, 780 of devices 600, 700 are each movable between an extended position (as shown in FIGS. 6a and 7a) and a retracted position (as shown in FIGS. 6b and 7b).

The retraction mechanisms 680, 780 are moved between the extended position and the retracted position by a user twisting a lower casing 683, 783 of the respective device 600, 700 relative to an upper casing 605, 705 of the device 600, 700. The lower casing 683, 783 acts as a driving member to cause the movement of the retraction mechanisms 680, 780 between the extended position and the retracted position. In these embodiments, the lower casing 683, 783 is twisted in a first direction to move the retraction mechanism 680, 780 to the retracted position, and the lower casing 683, 783 is twisted in a second direction, that is different to the first direction, to move the retraction mechanism 680, 780 to the retracted position. The second direction is a reverse direction of the first direction and the twisting motion of the lower casing 683, 783 is back-and-forth along a predetermined path. In other embodiments, the lower casing 683, 783 may twist in one direction to move the retraction mechanism 680, 780 between the extended position and the retracted position. In such embodiments the first direction is the same as the second direction.

In some embodiments, the retraction mechanism is moved between the extended position and the retracted position by a user sliding the driving member, for example the lower casing, of the respective device. In some embodiments, such as device 700, described below, the retraction mechanism may be movable by twisting and sliding the lower casing. In other embodiments, the retraction mechanism may be movable by independently twisting or sliding the lower casing. In such embodiments that refer to twisting, the twisting comprises a rotation of the lower casing in a predetermined way.

When the retraction mechanism 680 of device 600 is in the extended position (shown in FIG. 6a), in use, the part 12 of the consumable 10 is exposed to a user of the device 600 for inhalation when the consumable 10 is positioned in an aerosol generating zone 611. When the retraction mechanism 680 of device 600 is in the retracted position (shown in FIG. 6b), in use, the part 12 of the consumable 10 is retracted into the chamber 610 compared with when the retraction mechanism 680 is in the extended position.

The broken lines in FIGS. 6a and 6b (and FIGS. 7a and 7b) represent features that are concealed from a user's view. In the view shown in FIG. 6b, the part 12 of the consumable 10 (that is exposed in FIG. 6a) is fully retracted in the device 600, such that part 12 is concealed from the user's view. In the view shown in FIG. 6a, the part 12 of the consumable 10 is fully extended from the opening 612 in the chamber 610 of the device 600 and can be seen by the user in the view shown in FIG. 6a. In the fully extended position, the part 12 cannot be further extended from the device 600 by further action of the retraction mechanism 680. When the retraction mechanism 680 is between the retracted position and the extended position, the retraction mechanism 680 is configured to continuously move further away from the retracted position to further extend the part 12 from the chamber 610.

In this embodiment, the retraction mechanism 680 of device 600 provides movement of part 12 of the consumable 10 in a continuous manner between a first limit and a second limit. The first limit is a limit of retraction, which is referred to as the retracted position as shown in FIG. 6a. The second limit is a limit of extension, which is referred to as the extended position as shown in FIG. 6b. The retraction mechanism 680, and part 12, can be positioned anywhere between the first limit and the second limit because the retraction mechanism 680, and part 12, is configured to move in a continuous manner.

In other embodiments, movement of the retraction mechanism, and thus movement of the part to be exposed, may be intermittent, such that the part to be exposed is movable between a plurality of discrete intervals. In such embodiments, the retraction mechanism is retractable from the extended position to a plurality of positions, wherein one of the plurality of positions comprises the retracted position and another one of the plurality of positions comprises an intermediate position between the extended position and the retracted position.

When the retraction mechanism 780 of device 700 is in the extended position (shown in FIG. 7a), in use, a part 13 of a mouthpiece 11 is exposed for inhalation. In contrast to device 600, a consumable 10 inserted into device 700 remains concealed in the device 700 and does not become exposed when the retraction mechanism 780 is moved between the extended position (as shown in FIG. 7a) and the retracted position (as shown in FIG. 7b). Instead, the consumable 10 moves within device 700, by action of the retraction mechanism 780, so that the consumable is positioned in the chamber 710 when the mouthpiece 11 is fully extended. In other embodiments, the consumable 10 may be immovable within the device 700 by action of the retraction mechanism 780, so that the consumable 10 is held in the chamber 710 when the retraction mechanism 780 is moved between the extended position and the retracted position. When the retraction mechanism 780 of device 700 is in the extended position, an inhalable medium, such as aerosol, can be generated from the aerosol-generating material of the consumable 10 because the aerosol-generating material is moved to an aerosol generating zone 711.

When the retraction mechanism 780 of device 700 is in the retracted position, in use, the part 13 of the mouthpiece 11 is retracted into the chamber 710 compared with when the retraction mechanism 780 is in the extended position. The retraction mechanism 780 in device 700 is particularly advantageous because when the retraction mechanism 780 is in the extended position (FIG. 7a), the device 700 remains as compact as the device 700 when the retraction mechanism 780 is in the retracted position (FIG. 7b). That is, in this embodiment, an overall length L1 of the device 700 in the extended position (FIG. 7a) is almost identical to an overall length L2 of the device 700 in the retracted position (FIG. 7b). In other embodiments, the overall length L1 of the device 700 in the extended position may be identical to the overall length L2 of the device 700 in the retracted position. In this embodiment, the difference between overall length L1 of the device 700 in the extended position and overall length L2 is of the device 700 in the retracted position is around 2%. In other embodiments, the difference may be less than 5%, for example.

In device 700, movement of the part 13 of the mouthpiece 11 is intermittent between a first limit (the retracted position) and a second limit (the extended position). In other embodiments, movement of part 13 may be continuous between the first limit and the second limit, as described above in relation to part 12 of the consumable 10 in device 600.

In the view shown in FIG. 7a, the part 13 of the mouthpiece 11 that is to be exposed is fully extended from the opening 712. That is, part 13 cannot be extended further by action of the retraction mechanism 780 than what is shown in FIG. 7a because the retraction mechanism 780 is at a first limit. The first limit is a limit of extension of the retraction mechanism 780. In the view shown in FIG. 7b, the part 13 of the mouthpiece 11 is fully retracted. That is, part 13 cannot be further retracted than the view shown in FIG. 7b by further action of the retraction mechanism 780 because the retraction mechanism 780 is at a second limit. The second limit is a limit of retraction of the retraction mechanism 780.

In the embodiments shown in FIGS. 6a, 6b, 7a and 7b, the respective retraction mechanisms 680, 780 are each manually operable by a user, as described in more detail with reference to each of the devices 600, 700.

In other embodiments, the retraction mechanisms 680, 780 may be electronically or electro-mechanically operated by a controller, such as the controller 330, 430 previously described. In such examples, the device may comprise a motor to provide a driving force required to move the respective retraction mechanism. The advantage of electronical operation of the retraction mechanisms 680, 780 is that the number of moving parts on an outer surface of the device is minimised because any driving member of the retraction mechanism can be concealed from the user's view. This reduces the risk of ingress of foreign objects because all movable parts are provided internally of the device, except for the part to be exposed (such as part 12 of a consumable 10, as discussed in device 600, or part 13 of a mouthpiece 11, as discussed in device 700).

The devices 600, 700 comprise a plurality of external components. A first one of the plurality of external components is a housing member 605, 705. The housing member 605, 705 is provided as the upper casing of the device 600, 700. The housing member 605, 705 houses various internal components of the respective device 600, 700. For example, the housing member 605, 705 is configured to house a controller and a power source (not shown), such as the controller 330, 430 and power source 340, 440 previously described.

In this embodiment, the retraction mechanism 680 is manually operable by a user twisting the lower casing 683 in direction M1 to cause the retraction mechanism 680 and the consumable 10 to retract into the device 600 in direction M2.

The retraction mechanism 680 of device 600 is principally the same as the retraction mechanism 380 of device 300, as discussed previously. That is, the retraction mechanism 680 is moved between the extended position and the retracted position by a user twisting the lower casing 683 in direction M1, which causes a consumable support 686 to turn about the longitudinal axis 618 of the chamber 610 in direction M3 to move longitudinally relative to the threaded portion (not shown in FIGS. 6a and 6b but corresponds to threaded portion 316 of FIGS. 3a and 3b) in direction M2. The lower casing 683 is therefore a driving member that is configured to rotate relative to the upper casing 605 (provided as a housing member) to cause the consumable support 686 to reciprocate relative to the upper casing 605, in use. The consumable 10 is also caused to rotate in direction M3 by rotation of the rotational mechanism 682 as the retraction mechanism 680 and the consumable 10 retracts. This results in a helical movement of the rotational mechanism 682 and the consumable 10.

Although in this embodiment, the driving member, provided in the form of a lower casing 683, is movable and the housing member, provided in the form of an upper casing 605, is static, in other embodiments, the housing member may also be movable. That is, the housing member (upper casing 605) may be movable in combination with the driving member (lower casing 683) to cause relative reciprocation between the reciprocation component (the consumable support 686) and the driving member, in use. In some embodiments, movement of the driving member (lower casing 683) and the housing member (upper casing 605) may comprise movement along a respective helical path. In some embodiments, the respective helical path is formed from a single continuous path.

The helical movement discussed above is determined by the threaded portion. In other embodiments, the helical movement may not be determined by the threaded portion. In this embodiment, direction M3 is the same as direction M1. In other embodiments, the consumable 10 may not be caused to rotate by movement of the rotational mechanism 682 as the consumable 10 retracts. In yet other embodiments, the consumable 10 may be caused to rotate in the opposite direction to direction M1 as the retraction mechanism 780 retracts.

In device 600, the consumable support 686 is a reciprocation component that is configured to reciprocate along an axis of reciprocation. In this embodiment, the axis of reciprocation of the consumable support 686, and the axis of rotation of the lower casing 683, correspond to the longitudinal axis 618 of the chamber 610.

In this embodiment, the consumable support 686 is connected to the lower casing 683, on an outer surface of the device 600, via a connector 684. When the user twists the lower casing 683, the retraction mechanism 680 is moved between the extended position and the retracted position, because the consumable support 686 turns about the longitudinal axis 618 of the chamber 610 and moves longitudinally relative to a threaded portion (not shown but example provided by threaded portion 316 of device 300).

In this embodiment, the connector 684 is a connecting rod. In other embodiments, the connector 684 (or connecting rod) may comprise a plurality of parts.

In other embodiments, the rotational mechanism of device 600 may be configured to rotate the consumable 10 about an axis perpendicular to a longitudinal axis of the consumable 10 (not shown). For example, the rotational mechanism of device 600 may be configured to move the consumable 10 from a position in which the consumable 10 protrudes substantially perpendicularly from an outer surface of the device 600 to a position in which the consumable lies substantially parallel and flush to the outer surface of the device 600.

In the device 600, shown in FIGS. 6a and 6b, the retraction mechanism 680 comprises a rotational mechanism 682 configured to move the retraction mechanism 680 between the extended position (FIG. 6a) and the retracted position (FIG. 6b). An example of a retraction mechanism 680 and rotational mechanism 682 is the retraction mechanism 380 and rotational mechanism 382, respectively, as described in relation to device 300, and as shown in FIGS. 3a and 3b.

The lower casing 683 is a second one of the plurality of external components of the device 600. That is, the lower casing 683 is configured to rotate about an axis of rotation relative to the upper casing 605 to cause the consumable support 686, upon which the consumable 10 rests in use, to reciprocate relative to the upper casing 605, in use.

In this embodiment, the upper casing 605 is a barrier for concealing elements of the device 600 or elements for use with the device 600. For example, the upper casing 605 fully conceals the consumable support 686 from the user's view when the retraction mechanism 680 is in both the extended position (FIG. 6a) and the retracted position (FIG. 6b). The upper casing 605 is configured to partially conceal the consumable 10 from the user's view when the retraction mechanism 680 is in the extended position. The upper casing 605 is configured to fully conceal the consumable 10 from the user's view when the retraction mechanism 680 is in the retracted position.

In device 700, shown in FIGS. 7a and 7b, the driving member of the retraction mechanism 780 comprises a helical mechanism 785. The helical mechanism 785 combines sliding and rotation movement such that the driving member, in the form of a lower casing 783, moves helically relative to the housing member. As with device 600, the housing member of device 700 is an upper casing 705 of the device 700.

In this embodiment, the helical mechanism 785 comprises the lower casing 783 of the device 700 that is configured to rotate about axis 718 in direction M1 and slide along axis 718 in direction M2 relative to the upper casing 705. The combination of the rotation and sliding movement is synchronous such that the overall movement is helical. That is, helical movement of the lower casing 783 about the upper casing 705 is provided in this embodiment by the helical mechanism 785. In other embodiments, the driving member may be configured to slide or rotate to move the retraction mechanism between the extended position (FIG. 7a) and the retracted position (FIG. 7a).

In other embodiments, the driving member may be a component, other than a component for housing internal parts of the device 700, that is configured to be slidable relative to the casing of the device 700. The slider 481, shown in the embodiment of FIGS. 4a and 4b, is an example of a component, other than a component for housing internal parts of the device 700, that is configured to be slidable relative to the casing of the device 700.

The retraction mechanism 780 of device 700 is principally the same as the retraction mechanism 380 of device 300, as discussed previously. The exception is that the lower casing 783 comprises a cavity 787 that receives a portion of the upper casing 705. The cavity 787 allows the upper casing 705 to slid into and out of the lower casing 705 when operating the retraction mechanism 780. In other embodiments, the cavity 787 may be provided in the upper casing 705, rather than the lower casing 783, such that the lower casing 783 is configured to slid into and out of the upper casing 705.

In device 700, the retraction mechanism 780 is moved between the extended position and the retracted position by a user twisting the lower casing 783 in direction M1 to operate the helical mechanism 785. The twisting of the lower casing 783 causes the connector 784 to turn about the longitudinal axis 718 of the chamber 710 in direction M1 and move longitudinally relative to a threaded portion (not shown in FIGS. 7a and 7b but corresponding to threaded portion 316 of FIGS. 3a and 3b) in direction M2. The lower casing 783 is therefore a driving member that is configured to rotate and slide relative to the upper casing 705 (provided as a housing member) to cause the mouthpiece 11 to reciprocate relative to the upper casing 605, in use.

In this embodiment, the connector 784 is a connecting rod. In other embodiments, the connector 784 (or connecting rod) may comprise a plurality of parts.

As discussed in relation to device 600, the movement of the lower casing 783 and the connector 784 in device 700 is helical, as determined by the threaded portion. In other embodiments, the helical movement may not be determined by the threaded portion.

When the retraction mechanism 780 is moved between the extended position and the retracted position by the twisting motion of the lower casing 783 in direction M1, the mouthpiece 11 is caused to turn about the longitudinal axis 718 in direction M3. The consumable 10 is also caused to rotate in direction M3 by movement of the helical mechanism 785 as the retraction mechanism 780 and the consumable 10 retracts. This results in a helical movement of the mouthpiece 11 and consumable 10. In this embodiment, direction M3 is the same as direction M1. In other embodiments, the mouthpiece 13 and/or consumable 10 may not be caused to rotate by movement of the helical mechanism 785 as the retraction mechanism 780 retracts. In yet other embodiments, the mouthpiece 13 and/or consumable 10 may be caused to rotate in the opposite direction to direction M1 as the retraction mechanism 780 retracts.

In device 700, the mouthpiece 13 is a reciprocation component that is configured to reciprocate along an axis of reciprocation. In this embodiment, the axis of reciprocation of the mouthpiece 13, and the axis of rotation of the lower casing 783, correspond to the longitudinal axis 718 of the chamber 710.

Although in this embodiment, the driving member, provided in the form of a lower casing 783, is movable relative to the upper casing 705 and the housing member, provided in the form of the upper casing 705, is static relative to the lower casing 783, in other embodiments, the housing member may also be movable. That is, the housing member (upper casing 705) may be movable in combination with the driving member (lower casing 783) to cause relative reciprocation between each of the reciprocation components (the mouthpiece 13 and chamber 710) and the driving member, in use. In some embodiments, movement of the driving member (lower casing 783) and the housing member (upper casing 705) may comprise movement along a respective helical path. The respective helical path may be formed from a single continuous path.

The respective aerosol generating zones 611, 711 of devices 600, 700 are positioned in the respective upper casings 605, 705. The aerosol generating zones 611, 711 are static with respect to the respective upper casings 605, 705 and are not configured to move when the respective retraction mechanisms 680. 780 are in operation. In both devices 600, 700, the aerosol-generating material of the consumable 10 is caused to move with respect to the aerosol generating zones 611, 711 by operation of the respective retraction mechanisms 680. 780, in use. This allows the aerosol-generating material of the consumable 10 to be positioned in the aerosol generating zones 611, 711 for generating an inhalable medium.

In contrast to the chamber 610 of device 600, the chamber 710 configured to receive the consumable 10 comprising aerosol-generating material is the reciprocation component of the device 700. In this embodiment, the chamber 710 is provided in a connection rod 784 that is rotated when the user twists the lower casing 783, in use.

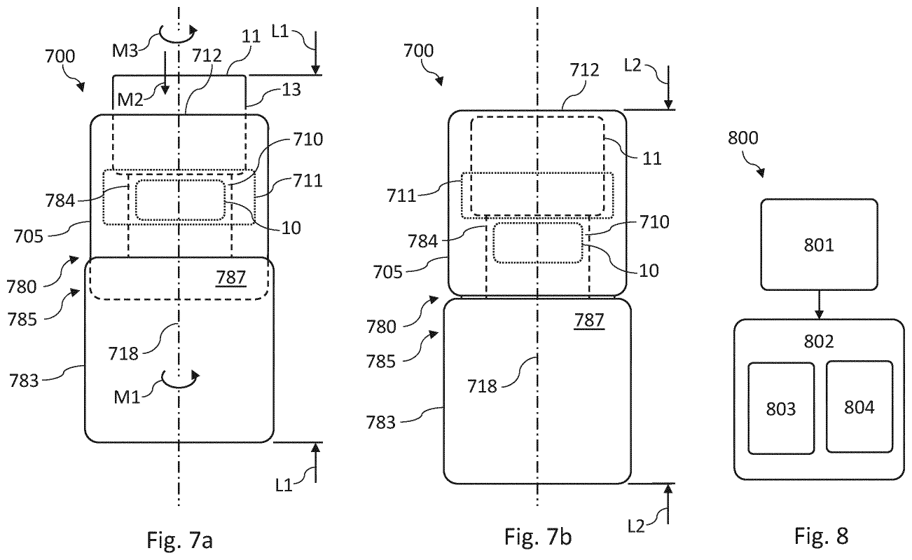

FIG. 8 shows an illustration of a method 800 of arranging an aerosol provision device according to an embodiment of the disclosure. The method 800 comprises relatively moving 801 a driving member and a housing member for at least partially housing a reciprocation component to cause relative reciprocation between the reciprocation component and the housing member.

In this embodiment, the relatively moving 801 the driving member and housing member comprises twisting the driving member. The twisting the driving member may be achieved by a user of the aerosol provision device holding the housing member in one hand and twisting the driving member by the other hand.

In this embodiment, the relative reciprocation 802 causes an uncovering 803, at least partially, of the reciprocation component by the housing member. Relative reciprocation 802 also causes a covering 804, at least partially, of the reciprocation component by the housing member.

In this embodiment, the uncovering 803 and covering 804 are brought about by twisting the driving member in opposing directions. In other embodiments, the relative rotation to cause the uncovering 803 and covering 804 may be in the same direction.

The devices 600, 700, as previously described, can be used, where discussed, in the operation of the method 800. Furthermore, the relatively moving 801 and/or relative reciprocation 802 may be electronically or electro-mechanically operated by a controller.

Embodiments of the present disclosure comprise an aerosol provision system comprising: a device 100, 200, 300, 400, 600, 700 according to an embodiment of the present disclosure and a consumable 10 comprising aerosol-generating material. The consumable 10 is for receipt in the chamber 110, 210, 310, 410 of the device 100, 200, 300, 400, 610, 710. In use, the device 100, 200, 300, 400, 600, 700 is configured to generate an inhalable medium from the aerosol-generating material.

For the avoidance of doubt, where in this specification the term “comprises” is used in defining the disclosure or features of the disclosure, embodiments are also disclosed in which the disclosure or feature can be defined using the terms “consists essentially of” or “consists of” in place of “comprises”.

The various embodiments described herein are presented only to assist in understanding and teaching the claimed features. These embodiments are provided as a representative sample of embodiments only and are not exhaustive and/or exclusive. It is to be understood that advantages, embodiments, examples, functions, features, structures, and/or other aspects described herein are not to be considered limitations on the scope of the disclosure, and that other embodiments may be utilised, and modifications may be made without departing from the scope of the disclosure. Various embodiments of the disclosure may suitably comprise, consist of, or consist essentially of, appropriate combinations of the disclosed elements, components, features, parts, steps, means, etc, other than those specifically described herein. In addition, this disclosure may include other inventions not presently claimed, but which may be claimed in future.

1. An aerosol provision device, the device comprising:
a chamber for receiving a consumable comprising aerosol-generating material, wherein, in use, part of the consumable protrudes from the chamber;
an aerosol generator for generating an inhalable medium from the consumable received in the chamber;
a controller for controlling the supply of power from a power source to the aerosol generator; and
a movable component for at least partially covering the part of said consumable that protrudes from the chamber in use, wherein the movable component is movable between a first position, in which the part of the consumable is exposed, and a second position, in which the part of the consumable is at least partially covered;
wherein the controller is configured to supply a different amount of power when the movable component is in the first position compared with when the movable component is in the second position.

2. The device of claim 1, wherein the movable component is configured such that, in the second position, the movable component at least partially covers an opening into the chamber, the consumable being insertable into the chamber via the opening.

3. The device of claim 1, wherein the movable component is configured to rotate about a hinge between the first and second positions.

4. The device of claim 1, wherein the movable component is configured to slide between the first and second positions.

5. The device of claim 1, wherein the movable component is completely detachable from the device such that, in the first position, the movable component is removed from a main body of the device and, in the second position, the movable component is removably connected to the main body of the device.

6. The device of claim 1, comprising a retraction mechanism movable between an extended position in which, in use, the part of the consumable is exposed, and a retracted position in which, in use, the part of the consumable is at least partially retracted into the chamber compared with when the retraction mechanism is in the extended position.

7. The device of claim 6, wherein the retraction mechanism comprises a rotational mechanism configured to move the retraction mechanism between the extended and retracted positions, and wherein the aerosol provision device comprises a plurality of external components rotatable relative to each other wherein a first one of the plurality of external components is configured to rotate relative to a second one of the plurality of external components to move the retraction mechanism between the extended and retracted positions.

8. (canceled)

9. The device of claim 6, wherein the retraction mechanism comprises a slider configured to move the retraction mechanism between the extended and retracted positions, wherein, in use, the slider causes the consumable to translate relative to the chamber along a longitudinal axis of the chamber.

10. The device of claim 6, wherein movement of the movable component is coupled to movement of the retraction mechanism such that the movable component is in the first position when the retraction mechanism is in the extended position and the movable component is in the second position when the retraction mechanism is in the retracted position.

11. The device of claim 1, comprising a biasing member to bias the movable component towards the first position and/or the second position.

12. The device of claim 1, comprising a locking member to lock the movable component in the first position and/or the second position.

13. The device of claim 1, wherein, when the movable component is in the first position, the controller is configured to supply more power from the power source to the aerosol generator than when the movable component is in the second position.

14. The device of claim 1, wherein, when the movable component is in the first position, the controller is configured to supply sufficient power from the power source to the aerosol generator to generate an aerosol from the aerosol-generating material.

15. The device of claim 1, wherein, in use, the controller is configured to heat the consumable according to a predetermined heating profile when the movable component is in the first position and to interrupt the predetermined heating profile in the event that the movable component is moved to the second position, and
wherein the controller is configured to resume heating the consumable according to the predetermined heating profile in the event that the movable component is returned to the first position.

16. The device of claim 1, wherein, in use, the controller is configured to cause movement of the movable component from the first position to the second position in the event that a predetermined amount of time has elapsed since a puff by a user.

17. The device of claim 1, wherein, in use, the controller is configured to cause movement of the movable component from the first position to the second position a predetermined amount of time after the start of a usage session.

18. The device of claim 1, comprising a sensor to detect a position of the movable component, wherein the controller is configured to supply power to the aerosol generator from the power supply in accordance with the position of the movable component as determined by the sensor.

19. The device of claim 1, wherein, when the movable component is in the second position, the controller is configured to supply power from the power source to the aerosol generator to maintain the aerosol-generating material within a temperature range below an aerosol-generating temperature of the aerosol-generating material.

20. The device of claim 1, wherein, when the movable component is in the second position, the controller is configured to supply no power from the power source to the aerosol generator.

21. An aerosol provision system comprising:
the aerosol provision device of claim 1, and
a consumable comprising aerosol-generating material, the consumable configured for receipt in the chamber of the device,
wherein, in use, the device is configured to generate an inhalable medium from the aerosol-generating material.
